(19) United States
(12) Patent Application Publication
(10) Pub. No.: US 2007/0088235 A1
(43) Pub. Date: Apr. 19, 2007

(54) Inflatable massaging waist band

(76) Inventor: Jimmy Tseng, Fairfax, VA (US)

Correspondence Address: Jimmy Tseng, 12643 Buckleys Gate Drive, Fairfax, VA, 22030, US

(21) Appl. No.: 11/249,834

(22) Filed: Oct. 14, 2005

(51) Int. Cl. A61H 9/00

(52) U.S. Cl. 601/151; 601/148

(57) ABSTRACT

An inflatable massaging waistband, comprising mainly a front air bladder; a rear air bladder; two elastic band; five sets of hooks and loops; at least one air valve; two adjustment belts; a plurality of massage balls; and an air pump; to provide massage to the waist, back, and abdomen of a user.

### FIELD OF THE INVENTION

The present invention relates to an inflatable massaging waistband, in particular to an inflatable massaging waistband that can massage the human waist and abdomen.

### BACKGROUND OF THE INVENTION

Conventional devices for massaging human waist and abdomen mostly are of the types of massaging beds or chairs which are relatively expensive and heavy and thus it is not convenient.

Although some light-weight portable massaging “rods” or devices are available, they can only massage “local” areas of the waist and abdomen, instead of “whole” areas.

### SUMMARY OF THE INVENTION

An objective of the present invention is to provide an inflatable massaging waistband which is relatively inexpensive and light-weighted.

Another objective of the present invention is to provide an inflatable massaging waistband which can provide massage for whole waist and abdomen simultaneously.

### BRIEF DESCRIPTION OF THE DRAWINGS

FIG. 1 shows a front elevational view of a preferred embodiment of an inflatable massaging waistband of the present invention;

FIG. 2 shows a rear view of FIG. 1;

FIG. 3 shows a front elevational view similar to FIG. 1, with two adjustment belts partially turned over to show the parts under them;

FIG. 4 is similar to FIG. 3 and is in a position that the device shown in FIG. 3 is rotated 180° on the plane of the device;

FIG. 5 is similar to FIG. 4 in which the two adjustment belts are at different positions from those shown in FIG. 4;

FIG. 6-9 show the steps of putting the inflatable massaging waistband around the waist of a user;

FIG. 10 shows a schematic view of a rear air bladder and illustrates the positions of a hard board, some massage balls, and some gussets;

FIG. 11 illustrates a user using the inflatable massaging waistband during standing position;

FIG. 12 illustrates a user using the inflatable massaging waistband during sitting position;

FIG. 13 illustrates a user using the inflatable massaging waistband during lying down position;

FIG. 14 depicts a portion of the inflatable massaging waistband which is partially cut off after it is inflated;

FIG. 15 illustrates a front view of a front air bladder;

FIG. 16 illustrates a rear view of a front air bladder;

FIG. 17 illustrates a front view of a rear air bladder;

FIG. 18 illustrates a rear view of rear air bladder;

FIG. 19 illustrates a perspective view of the inflatable massaging waistband, with two adjustment belts attached (“closed”) to hooks and loops (Velcros);

FIG. 20 illustrates an inflating means (air pump) used with the inflatable massaging waistband of the present invention;

FIG. 21 shows a perspective view of an air pump used in the present invention;

FIG. 22 shows a perspective view of a portion of the air pump shown in FIG. 21;

FIG. 23 is a perspective view similar to FIG. 22, looking from a difference angle;

FIG. 24 is a top view of the parts shown in FIG. 22;

FIG. 25 is an exploded view of the parts shown in FIG. 22;

FIG. 26 is a longitudinal sectional view of the parts shown in FIG. 22;

FIG. 27 is a top view of the air pump, with a cover installed;

FIG. 28 is a bottom view of the air pump;

FIG. 29 is a schematic view depicting the hand and the air pump; and

FIG. 30 is a similar to FIG. 29, showing different angle.

FIG. 31 is a perspective view of the air valve that can be used on the inflatable massaging device;

FIG. 32 is similar to FIG. 31, with a lid closed the air valve;

FIG. 33 is an exploded view of the air valve; and

FIG. 34 is a longitudinal sectional view of the air valve, without showing the lid.

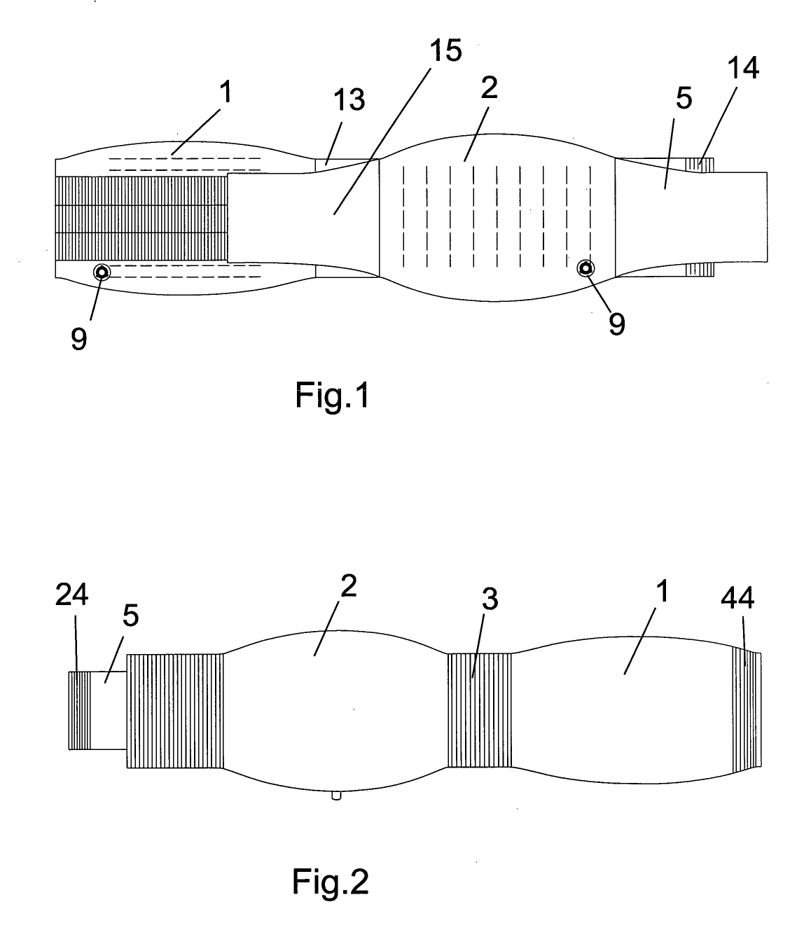

### DETAILED DESCRIPTION OF THE INVENTION

The inflatable massaging waistband of the present invention includes mainly a front air bladder 1, a rear air bladder 2, an elastic band 13 for connecting the front air bladder 1 and the rear air bladder 2. Another elastic band 3 is connected to another side of the rear air bladder 2. Hooks and Loops (Velcros) 14 is connected to another side of the elastic band 3. Two adjustment belts 5 and 15 are attached to the two sides of the rear air bladder 2, respectively. Two hooks and Loops (Velcro) 24 and 34 are connected to the adjustment belts 5 and 15, respectively. Hoots and Loops (Velcros) 4 is provided on the front side of the front air bladder 1, Hooks and Loops (Velcros) 44 is provided on the rear side of the front air bladder 1.

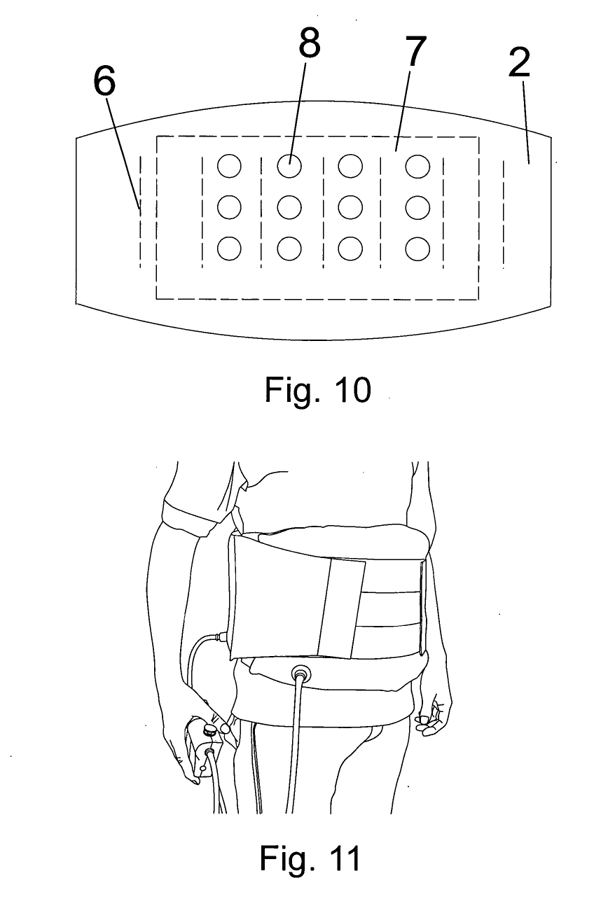

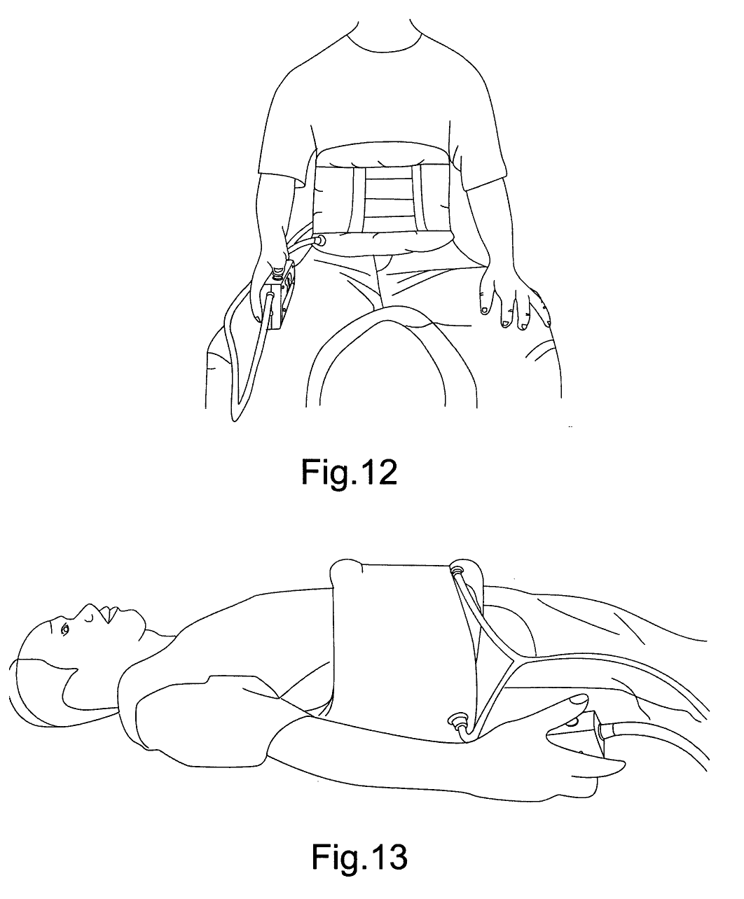

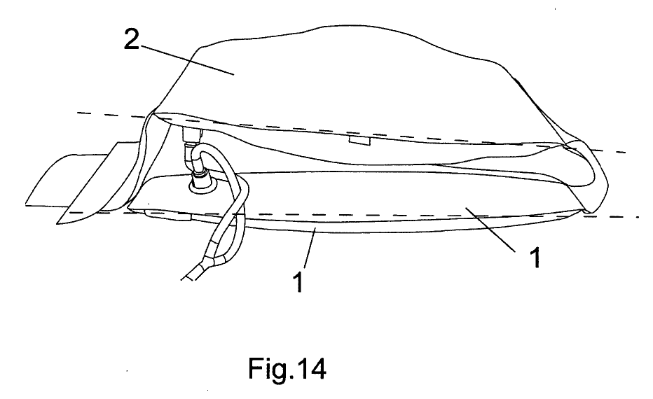

Each of the front air bladder 1 and the rear air bladder 2 consists of an inner air bladder 12 and a housing shell) 11. A plurality of gussets 6 is provided in the inner air bladder to keep the distance of two inner air bladder sheets. A plurality of welding lines 10 are provided in the inner air bladder 12 so as to divide it into several cells. The welding lines 10 are in the from of broken lines, i.e. welded sections and non-welded sections are arranged alternatively, so that each cells can communicate with each other. Two air inlets (valves) 9 and 19 are provided on the front air bladder 1, and the rear air bladder 2, respectively. As seen in FIG. 10 and 18, a plurality of massage balls 8 and a hard board 7 are provided on the rear air bladder 2. The purpose of the massage balls 8 is to stimulate pressure points on the back of the user when the inflatable massaging waistband is inflated. The purpose of the hard board 7 is to reduce the degree of being pushing away of the massage balls 8 when they are effecting pressurizing against the pressure points so that the stimulation to the pressure points can be enhanced. The inner side of the front air bladder 1 can be provided with some heating device or heating pad (not shown in the drawings).

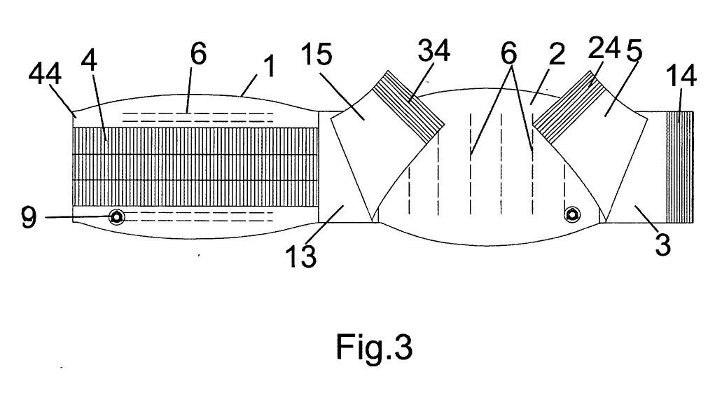

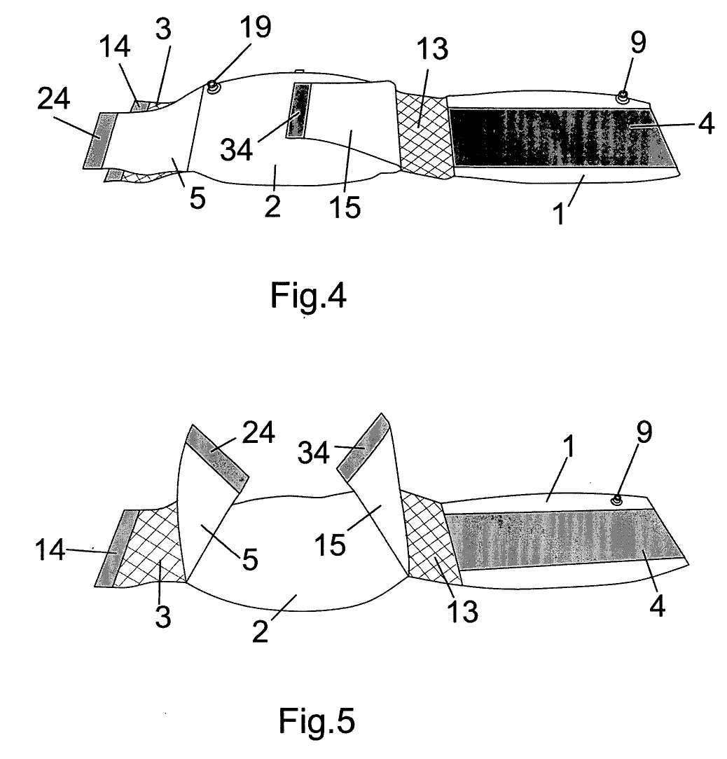

In FIG. 4, the hooks and Loops (Velcro) 24 on the left side is provided on the lower side as seen from FIG. 4. In FIG. 3, the hooks and loops (Velcro) 44 on the left side is provided on the lower side as seen from FIG. 3. The purpose of the elastic bands 3 and 13 is to provide some stretch ability to the inflatable massaging waistband and make it more comfortable to the user.

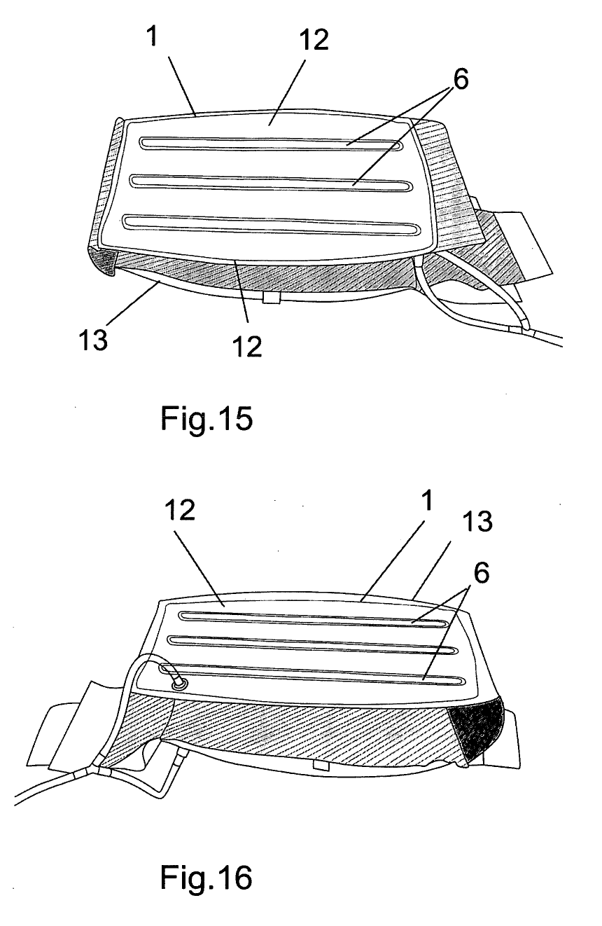

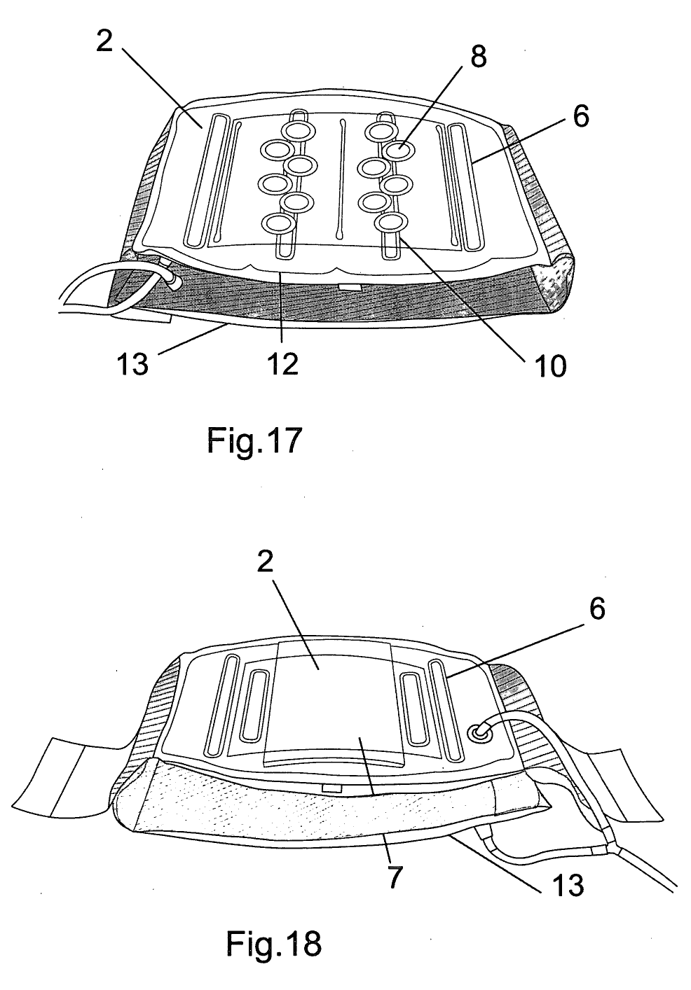

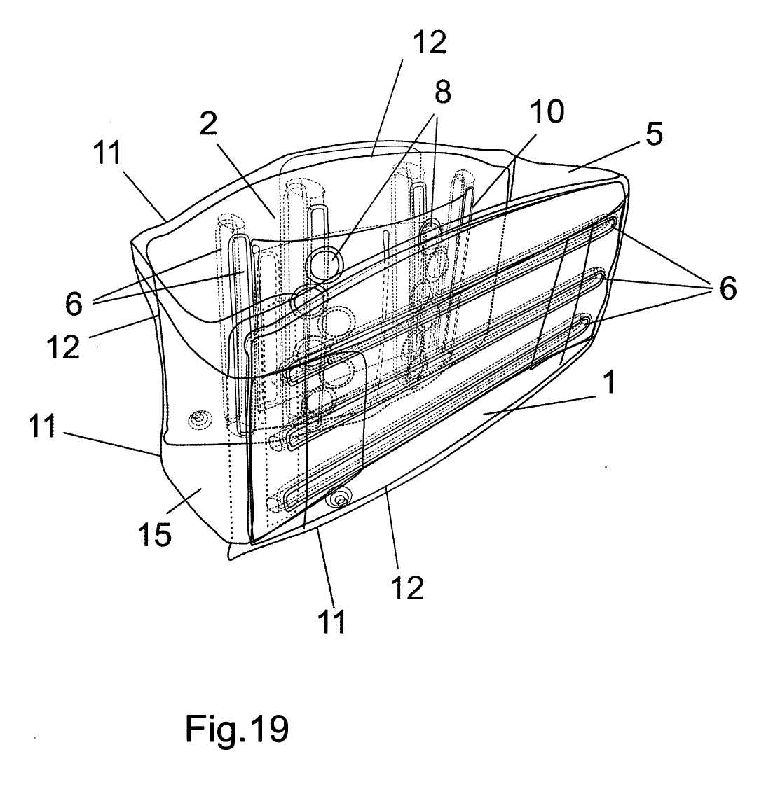

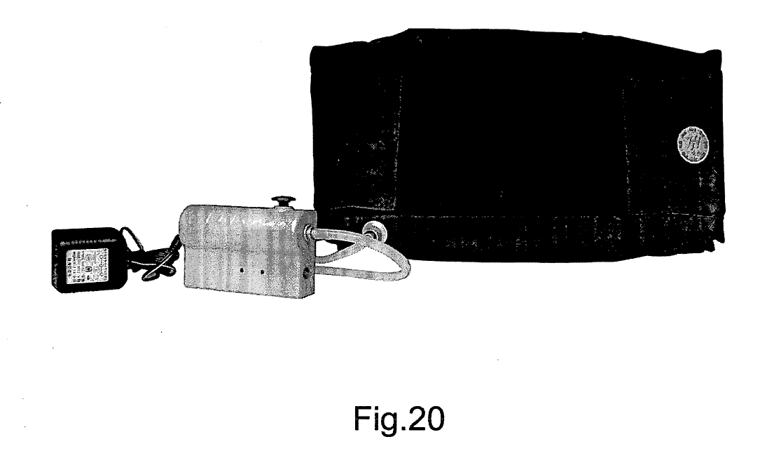

Please note that the gussets 6 in the front air bladder 1 are horizontal (FIG. 15 and 16) and the air cells therein are horizontal, the gussets 6 and the welding lines 10 in the read air bladder 2 are vertical, and the air cells therein are vertical. This arrangement enhances the comfort of the abdomen and the back of the user.

The housing (shell) 11 is made of soft fabric or other suitable material, the inner air bladder 12 is made of soft PVC (poly vinyl chloride), TPU (thermoplastic polyurethane), PU (Polyurethane), or other suitable material.

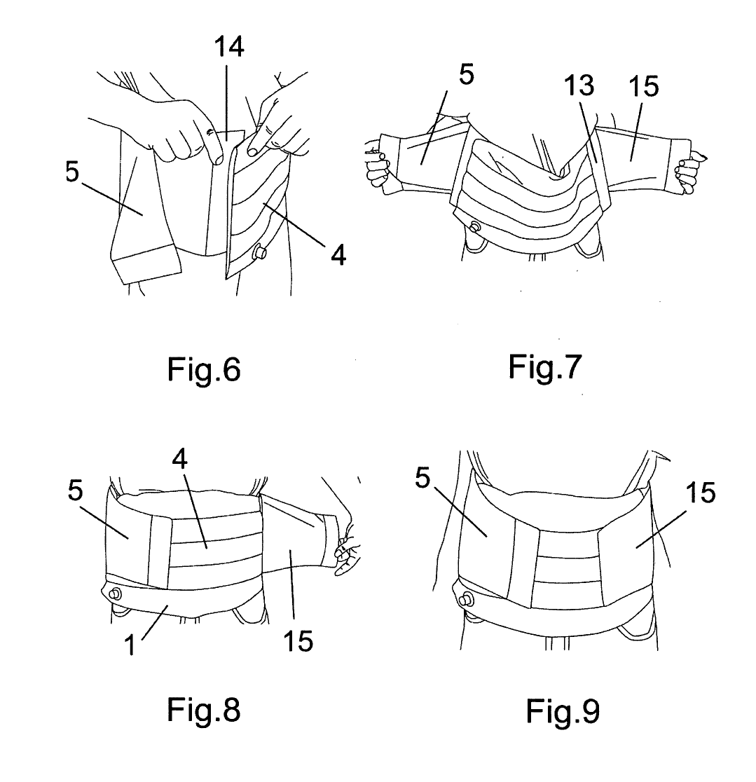

FIGS. 6-9 show the steps of putting the inflatable massaging waistband around the waist of a user.

In FIG. 6, two hands can be used to hold the inflatable massaging waistband, so that it can wrap around the waist loosely, one hand holds a portion close to the hooks and loops (Velcro) 14, the other hand holds a portion close to the hook and loops (Velcro) 44 (which is on the other side of the hooks and loops (Velcro) 4), so that the hooks and loops 14 can attach to hook and loops 44.

In FIG. 7, two hands can hold the adjustment belts 5 and 15, then with the hooks and loops 24 attached to the hooks and loops 4 (FIG. 8), then with the hooks and loops 34 attached to the hooks and loops 4 (FIG. 9), with a fist space between the waist and the waistband.

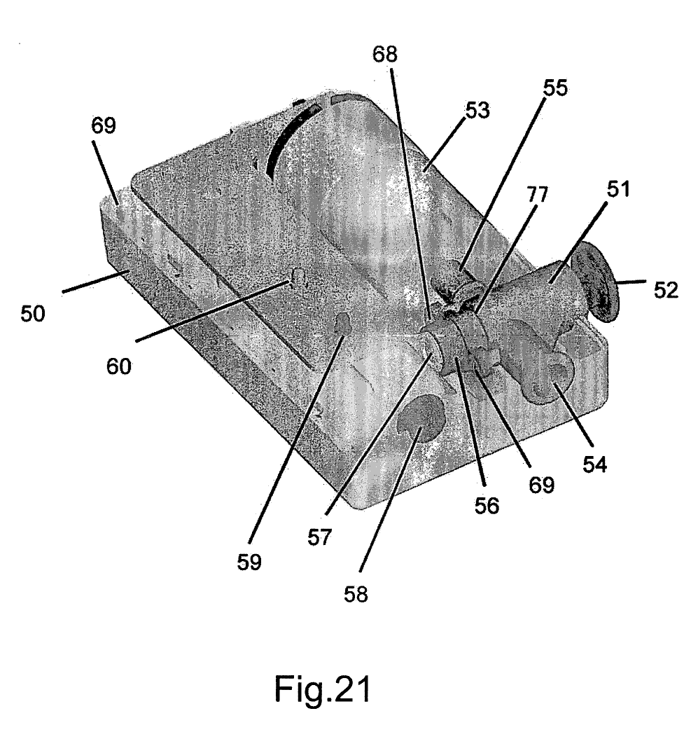

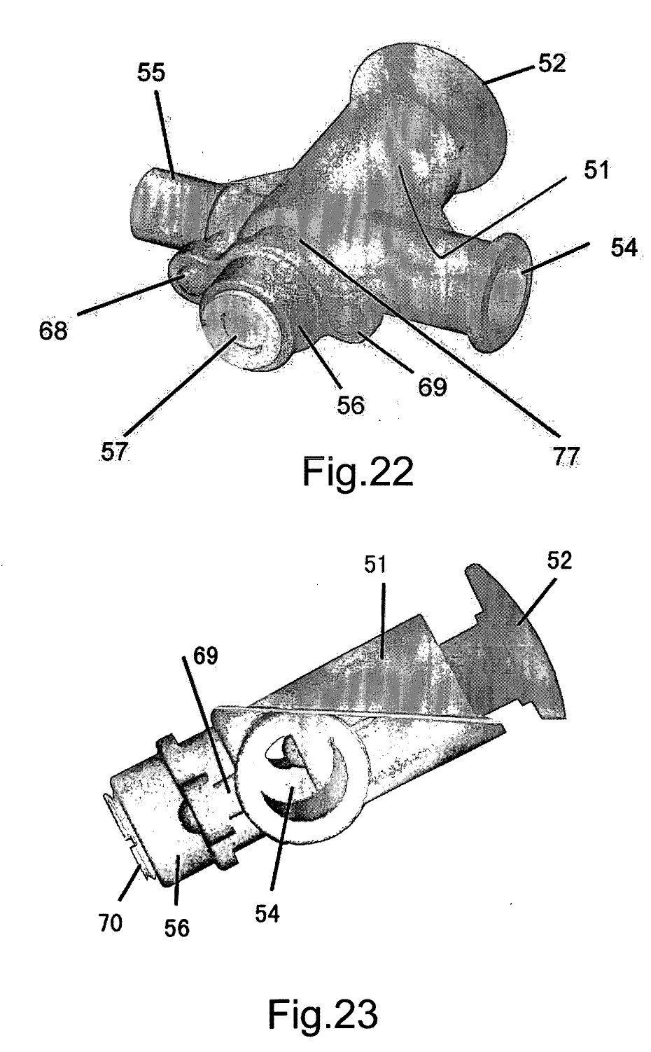

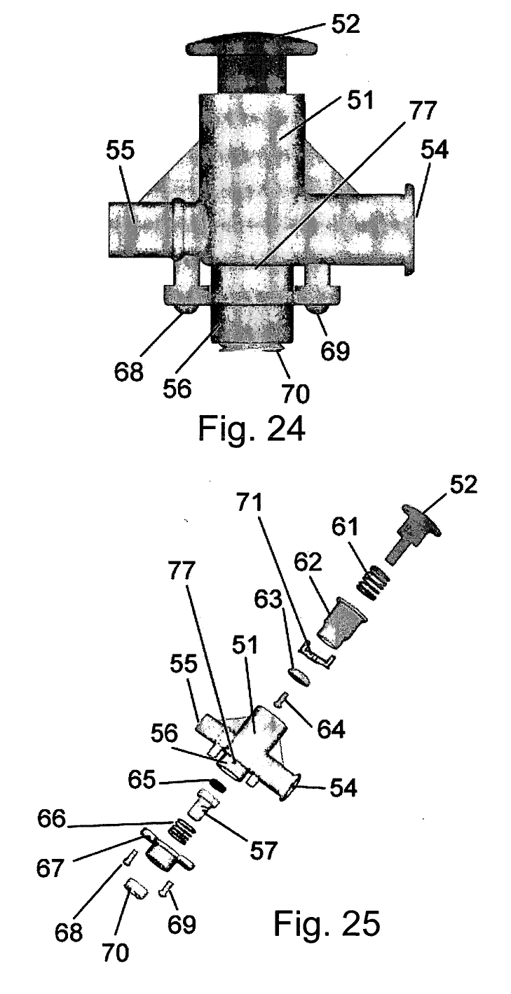

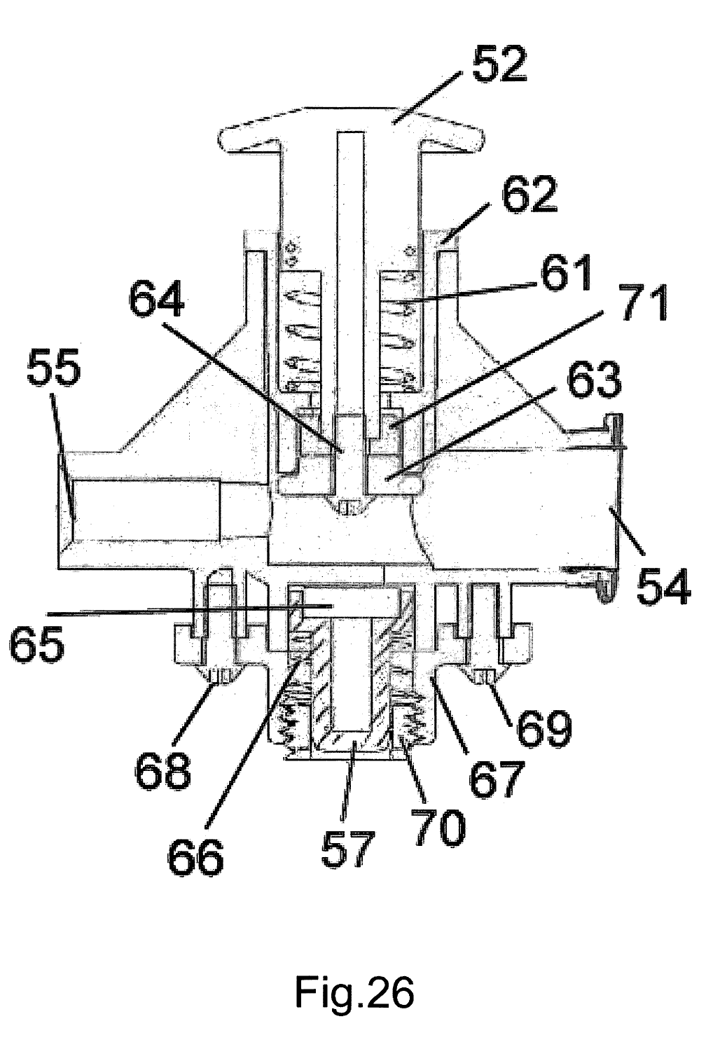

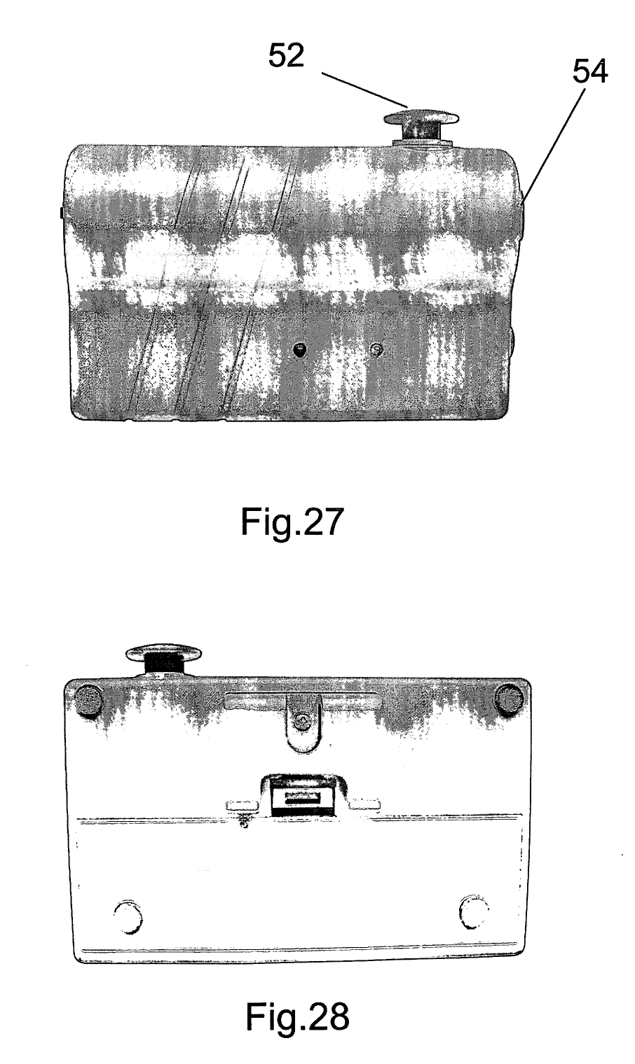

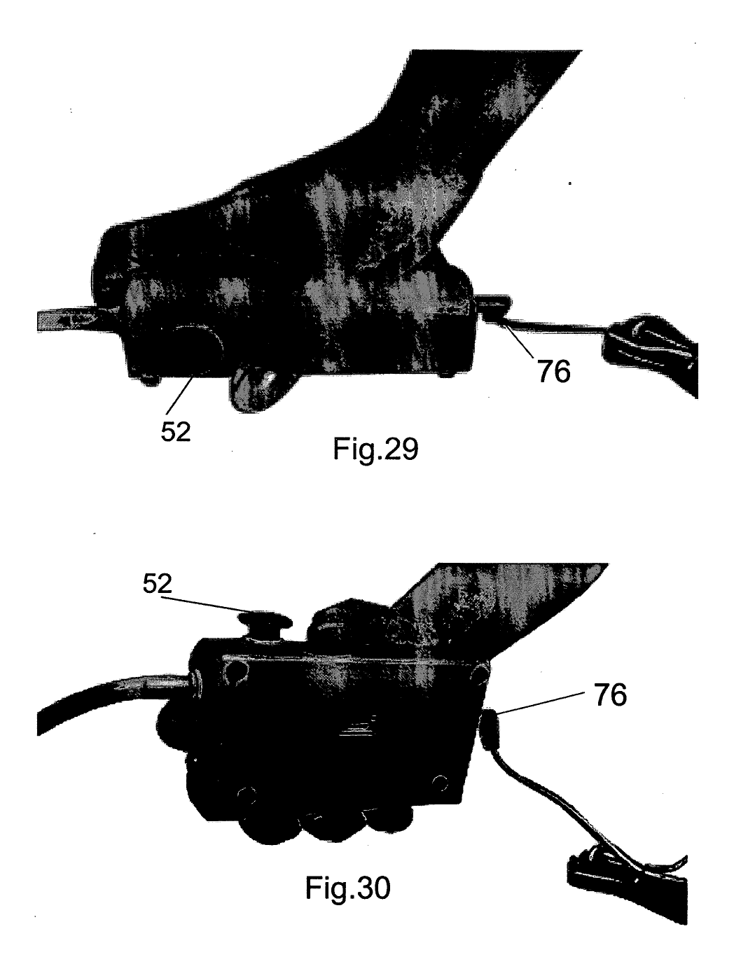

Please see FIGS. 21-26 for the detailed structure of the air pump 50. The air pump 50 comprises mainly a discharge valve button 52, a safety valve plunger 57, a pipe 51 for accommodating the discharge valve button 52 and relevant parts, a second pipe 56 for accommodating the safety valve plunger 57 and relevant parts, a pumping device 53, a pipe 55 in communicating with the pumping device 53, a pipe 54 for accommodating an end of an air tube having another end connected to the air valve of the inflatable massaging device of the present invention, and a starting button 58.

The discharge valve has the button 52, a spring 61, a socket 62, a fixation element 71, a piston 63, and a bolt 64 for fastening the button 52, the fixation element 71, and the piston 63 together. When the button 52 is pushed down, the piston 63, the fixation member 71 and the bolt 64 are pushed down simultaneously, and the air can be discharged from an air release hole 77.

The safety valve has the plunger 57, a piston 65, a spring 66, a stopper 67, a micro-adjustment member 70, and two bolts 68 and 69 for fastening the stopper 67 to the pipes 54 and 55. The micro-adjustment member 70 and the stopper 67 have corresponding threads so that the member 70 can be rotated to adjust and set safety pressure which is preferably 0.015 MPA (mega Pascal). When the air pressure in the air tube or pipe 54 is more than the set value, the plunger 57 and the piston 65 is pushed downward by the air pressure and excessive air can be discharged from the air release hole 77.

Indicating light 59 indicates the inflation of the air pump 50, indicating light 60 indicates that the power is “on”, A switch 72 is provided on the housing of the air pump 50, A socket 73 is also provided on the housing of the air pump 50 for the insertion of a plug (line) 76 of an adapter (ac/dc converter), A clip (or hook) 74 is provided on the housing of the air pump 50 for attaching the air pump 50 on a belt or pocket of the user. A battery compartment 75 is also provided on the housing for accommodating batteries.

When the user's hand (finger, preferably forefinger) pushes down the starting button 58, the pumping device 53 is energized to provide air to the air valve on the inflatable massaging device of the present invention through the pipes 53 and 54, and an air tube (not shown in the drawings 5), and thus the inflatable massaging device is inflated. When the user's hand (finger, preferably thumb) pushes down the safety valve plunger 57, air from the inflatable massaging device is discharged at air release hole 77 through the air valve, air tube, and the pipe 54, and thus the inflatable massaging device can be deflated.

In actual use, the user can choose one of the following three ways, or other suitable ways;
1. Push and release: the user continuously inflate the inflatable massaging device until the user can not tolerate, then deflate the same, then inflate and deflate it alternatively;
2. Continuous inflation: the user inflate the inflatable massaging device fully, then discharge about half of the air in that device, and then inflate it fully again. These steps can be repeatedly done;
3. Full inflation and full release: the user inflate the inflatable massaging device fully, then turn off the air pump 50, let the air stay in the inflatable massaging device for a while (e.g. 3-5 minutes), then deflate the inflatable massage device. These steps can be repeatedly done.

The purpose of alternatively inflating and deflating the inflatable massaging device is to exert pressure to the user's body part so as to massage it and stimulate pressure points; then let the body part relaxed when it is deflated.

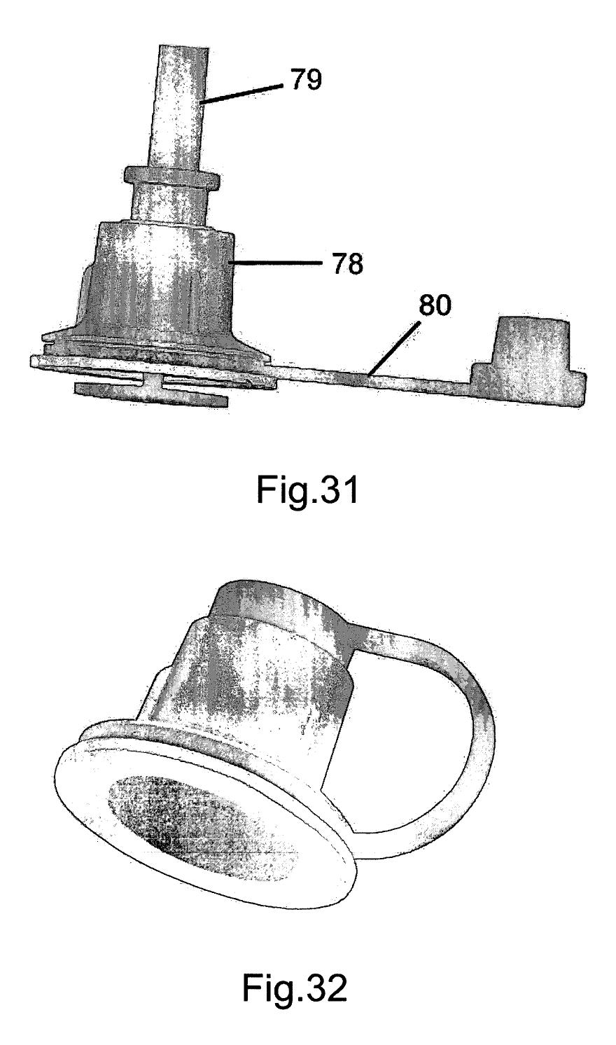

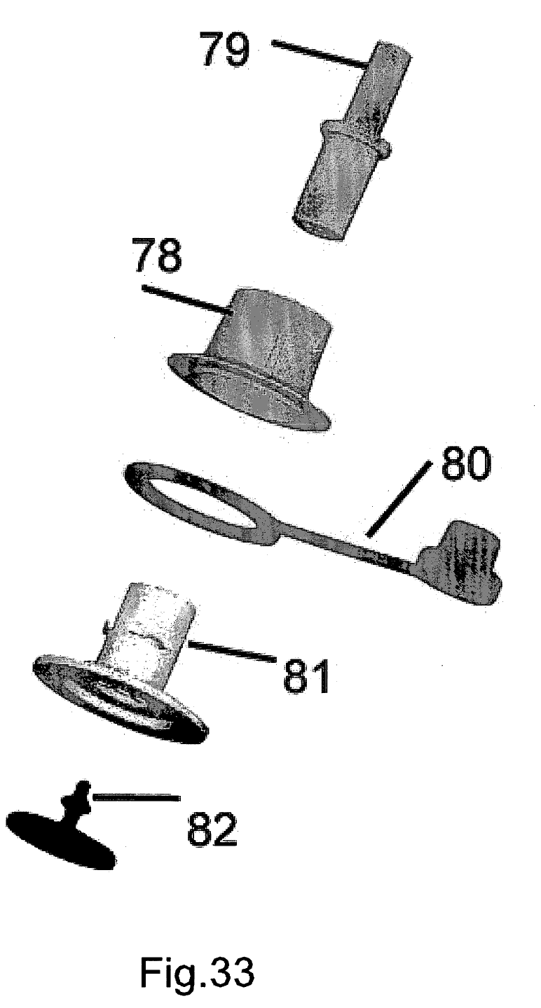

Please see FIGS. 31-34 for the detailed structure of the air valve, the air valve is including a housing 78, an inner element 81, a connecting element 79, a stopper 82, and a lid 80.

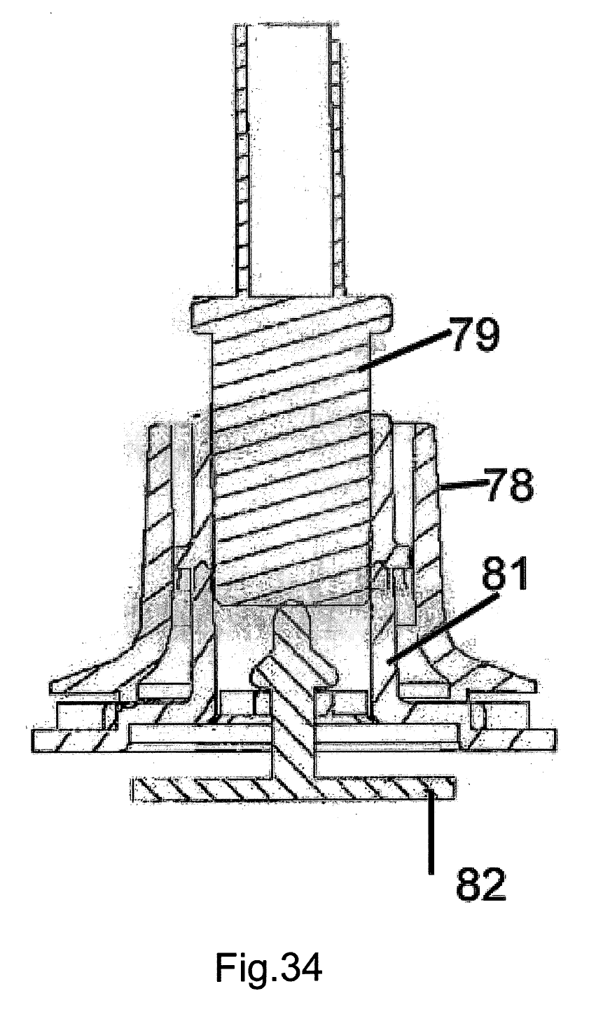

When the connecting element 79 is inserted into the inner element 81, it pushes down the stopper 82 and thus air can go from the air pump 50, an air tube (not shown in the drawings) which is inserted into the upper and of the connecting element 79, the connecting element 79, the gap between the stopper 82 and the inner element 81, and enter the inflatable massaging device of the present invention. (as shown in FIG. 34). When the connecting element 79 is removed from the air valve, the air pressure in the inflatable massaging device pushes the stopper 82 into a closed position. At this time, the lid 80 can be put on to help preventing the leakage of the air from the inflatable massaging device.

The advantage of this structure is that, at this status, the user can move around freely without the need of carrying the air pump 50.

When the user wants to release the air from the inflatable massaging device, a piece of stick or rod similar to the connecting element 79 can be inserted into the inner element 81 to push down the stopper 82 so that the air can be released.

1. An inflatable massaging waistband, comprising mainly a front air bladder; a rear air bladder; a first elastic band for connecting the front air bladder to the rear air bladder; a second elastic band for being connected to another side of the rear airbladder; a first sets of hooks and loops for being connected to another side of the first elastic band; two adjustment belts attached to the two sides of the rear air bladder; a second and third sets of hooks and loops for being connected to the two adjustment belts respectively; a fourth and fifth sets of hooks and loops provided on the front side and the rear side of the front air bladder respectively; at least one air valve; an air pump; and a plurality of massage balls provided on the inside of the rear air bladder; wherein the first and the fifth sets of hooks and loops can be attached together; the second and the third sets of hooks and loops can be attached to the fourth set of hooks and loops

2. The inflatable massaging waistband as in claim 1, wherein a plurality of gussets and welding can be provided inside the front and the rear air bladders to keep the air bladders in a suitable shape, and to divide them into a plurality of air cells, respectively; and wherein a heating device can be provided on the inside of the front air bladder.

3. The inflatable massaging waistband as in claim 1, further comprising a hard board on the inside of the rear air bladder to enhance the stimulation effects of the massage balls

4. The inflatable massaging device as in claim 1, wherein the air pump comprises mainly a housing, a safety valve, a discharge valve, a pumping device, a starting button, and indicating lights.

5. The inflatable massaging device as in claim 4, wherein the safety valve includes a plunger, a piston, a spring, a stopper, a micro-adjustment member, and two bolts.

6. The inflatable massaging device as in claim 4, wherein the discharge valve includes a button, a spring, a socket, a fixation element, a piston, and a bolt.

7. The inflatable massaging device as in claim 1, wherein is the air valve comprises a connecting element, a housing, an inner element, a lid, and a stopper.
